(19) United States
(12) Patent Application Publication
(10) Pub. No.: US 2016/0009888 A1
(43) Pub. Date: Jan. 14, 2016

(54) METHOD FOR PRODUCING CROSS-LINKED POLYETHYLENE- BASED RESIN EXPANDED BEADS

(71) Applicant: JSP CORPORATION, Tokyo (JP)

(72) Inventors: Masaharu OIKAWA, Yokkaichi-shi (JP); Tokunobu NOHARA, Yokkaichi-shi (JP); Nobumasa KOSHITA, Yokkaichi-shi (JP)

(21) Appl. No.: 14/791,885

(22) Filed: Jul. 6, 2015

(30) Foreign Application Priority Data
Jul. 9, 2014 (JP) 2014-141302

(51) Int. Cl. C08J 9/18; C08J 9/00

(52) U.S. Cl. CPC C08J 9/18; C08J 9/0023; C08J 9/0061; C08J 9/0028; C08J 2323/06

(57) ABSTRACT

A method for producing cross-linked polyethylene resin expanded beads, including dispersing polyethylene resin particles containing a halogen-containing flame retardant in a dispersing medium in an autoclave, impregnating the dispersed resin particles with an organic peroxide and cross-linking the polyethylene resin therewith at a specific temperature range determined by the melting point of the polyethylene resin and by melting point or glass transition temperature of the flame retardant, impregnating the dispersed resin particles with a blowing agent, and then foaming and expanding the resulting cross-linked polyethylene-based resin particles.

### BACKGROUND OF THE INVENTION

1. Field of the Invention

The present invention relates to a method for producing cross-linked polyethylene-based resin expanded beads and, more specifically to a method for producing flame retardant-containing, cross-linked polyethylene-based resin expanded beads.

2. Description of Related Art

Molded articles of cross-linked polyethylene-based resin expanded beads are used as packaging and cushioning materials, bed cores, anti-vibration and sound damping materials for floors or walls of houses and buildings, vibration damping materials for use in construction sites, etc. owing to their excellent flexibility, recovery from repeated compression, creep resistance characteristics and vibration damping characteristics. Recently, such molded articles when used in construction fields are demanded to have flame retardancy.

One known method for imparting flame retardancy to a synthetic resin is to incorporate a metal hydroxide filler, such as magnesium hydroxide and aluminum hydroxide, thereinto. Upon combustion of the resin, water is generated from the filler so that the heat of combustion is reduced. Also known is a method in which a halogen-containing organic flame retardant is added to a polyolefin resin (Japanese Kokai Publication No. JP-A-10-147661). The halogen-containing flame retardant achieves flame retardancy by being decomposed to yield decomposition gases which are adapted to capture radicals formed by combustion of the polyolefin resin and to exhibit a suffocation effect.

### SUMMARY OF THE INVENTION

With the method using the inorganic filler, it is necessary to add the filler in an amount of 50% by weight or more in order to achieve desired flame retardancy. Such a large amount of the filler causes breakage of the cells during foaming and expanding of resin particles, which in turn results in shrinkage or deformation of the obtained expanded beads. It is difficult, therefore, to obtain in-mold molded articles with good dimensional stability.

The method using the halogen-containing flame retardant has been found to cause a problem especially when the resin is cross-linked with an organic peroxide. Namely, the flame retardant reacts with the organic peroxide during fabrication of cross-linked expanded beads and, therefore, prevents desired cross-linkages from forming and also desired flame retardancy from being imparted to the resin. In order to solve the above-described problems, it might be considered effective to impregnate the resin particles with a flame retardant after cross-linking the resin particles or to lower the cross-linking temperature. These measures, however, cause deterioration of the production efficiency. Moreover, it becomes difficult to obtain expanded beads having good in-mold moldability.

It has now been found that when polyethylene-based resin particles which contain a halogen-containing flame retardant are cross-linked with an organic peroxide while controlling the cross-linking temperature within a specific range determined by the melting point of the polyethylene-based resin and also by the melting point or glass transition temperature of the flame retardant, it becomes possible to obtain cross-linked polyethylene-based resin expanded beads having excellent flame retardancy and excellent in-mold moldability. The present invention has been completed based on this finding.

In accordance with one aspect of the present invention there is provided:

[1] A method for producing cross-linked polyethylene-based resin expanded beads, comprising the steps of:

(a) dispersing polyethylene-based resin particles containing a halogen-containing flame retardant in a dispersing medium that is contained in a closed vessel, said polyethylene-based resin having a melting point of TM_{PE};

(b) impregnating the dispersed polyethylene-based resin particles with an organic peroxide and cross-linking the polyethylene-based resin of the dispersed polyethylene-based resin particles with the organic peroxide at a cross-linking temperature T1 that is not lower than TM_{PE} and is not higher than TM_{PE} plus 80° C.;

(c) impregnating the dispersed polyethylene-based resin particles with a blowing agent; and

(d) then foaming and expanding the resulting cross-linked polyethylene-based resin particles, which have been impregnated with the blowing agent,

wherein the cross-linking temperature T1 satisfies the following relationship:

T1<T2+30° C.

where T2 is a melting point or a glass transition temperature of the halogen-containing flame retardant, whichever is the lower.

In other aspects, the present invention provides:

[2] A method according to claim 1, wherein the resulting cross-linked polyethylene-based resin particles, which have been impregnated with the blowing agent are released from the closed vessel to an atmosphere having a pressure lower than that in the closed vessel to foam and expand the cross-linked polyethylene-based resin particles.
[3] A method according to above [1] or [2], wherein T2 is 130 to 350° C.;
[4] A method according to above [1] to [3], wherein the halogen-containing flame retardant is present in the polyethylene-based resin particles in an amount of 3 to 30 parts by weight based on 100 parts by weight of the polyethylene-based resin;
[5] A method according to any one of above [1] to [4], wherein the halogen-containing flame retardant is selected from the group consisting of brominated epoxy resins, brominated polyphenylene ethers and brominated triazine compounds;
[6] A method according to any one of above [1] to [5], wherein the halogen-containing flame retardant is a brominated epoxy resin having a weight average molecular weight of 8,000 to 80,000;
[7] A method according to any one of above [1] to [5], wherein the halogen-containing flame retardant is a brominated polyphenylene ether having a weight average molecular weight of 700 to 3,000;
[8] A method according to any one of above [1] to [7], wherein the dispersed polyethylene-based resin particles is impregnated with the organic peroxide at a temperature of 60 to 130° C.;
[9] A method according to any one of above [1] to [8], wherein the organic peroxide has a one hour half life temperature of 100 to 150° C.;
[10] A method according to any one of above [1] to [9], wherein the polyethylene-based resin particles contain antimony trioxide in an amount of 1 to 10 parts by weight based on 100 parts by weight of the polyethylene-based resin;
[11] A method according to any one of above [1] to [10], wherein the cross-linked polyethylene-based resin expanded beads have an apparent density of 15 to 200 g/L; and

The process according to the present invention can produce cross-linked polyethylene-based resin expanded beads that have excellent flame retardancy and show excellent moldability. Further, since the cross-linking of the polyethylene-based resin is carried out after forming polyethylene-based resin particles containing a halogen-containing flame retardant, the expanded beads can be produced with improved production efficiency. In the present specification, “polyethylene-based resin” is hereinafter occasionally referred to as “PE resin” and “cross-linked PE resin expanded beads” is hereinafter occasionally referred to as “PE resin expanded beads”.

Other objects, features and advantages of the present invention will become apparent from the detailed description of the preferred embodiments which follows.

### DETAILED DESCRIPTION OF THE PREFERRED EMBODIMENTS OF THE INVENTION

A method for producing cross-linked PE resin expanded beads according to the present invention includes the following steps (a)-(d):

(a) Dispersing step in which PE resin particles containing a halogen-containing flame retardant are dispersed in a dispersing medium contained in a closed vessel, the PE resin having a melting point of TM_{PE};
(b) Cross-linking step in which the PE resin particles dispersed in the closed vessel are impregnated with an organic peroxide, and in which the PE resin of the PE resin particles are cross-linked with the organic peroxide at a cross-linking temperature T1 that is not lower than TM_{PE} and is lower than TM_{PE} plus 80° C.;
(c) Blowing agent impregnating step in which the PE resin particles dispersed in the dispersing medium in the closed vessel are impregnated with a blowing agent; and
(d) Foaming step in which the cross-linked PE resin particles, which have been obtained in the foregoing steps and impregnated with the blowing agent, are released from the closed vessel to an atmosphere having a pressure lower than that in the closed vessel to foam and expand the cross-linked PE resin particles.

These steps are described in detail below.

### Dispersing Step (a):

In the dispersing step (a), PE resin particles containing a halogen-containing flame retardant are dispersed in a dispersion medium.

The PE resin used for preparing PE resin particles containing a halogen-containing flame retardant is preferably a resin containing 50 mol % or more of ethylene component units. Specific examples of the PE resin include high density polyethylene, medium density polyethylene, low density polyethylene, linear low density polyethylene, very low density polyethylene, ethylene-vinyl acetate copolymer, ethylene-propylene copolymer, ethylene-propylene-butene-1 copolymer, ethylene-butene-1 copolymer, ethylene-hexene-1 copolymer, ethylene-4-methylpentene-1 copolymer, ethylene-octene-1 copolymer, ethylene-methyl methacrylate copolymer, ethylene-ethyl acrylate copolymer, and mixtures of two or more of the above polymers and copolymers. Above all, low density polyethylene is preferred. The PE resin preferably has a flexural modulus (according to JIS K6922-2) of 100 to 500 MPa.

Using the above PE resin, PE resin particles containing a halogen-containing flame retardant may be prepared as follows. A kneaded mixture containing the PE resin and the flame retardant is extruded through a die attached to an extruder in the form of strands. The strands are cooled and then cut with a pelletizer into particles having an average weight per particle of preferably 0.1 to 10 mg. The extrusion temperature is preferably not lower than the melting point TM_{PE} of the PE resin and not higher than the decomposition initiation temperature of the halogen-containing flame retardant, more preferably between 150° C. and 250° C. Pelletization may be also carried out by a method in which the kneaded mass is extruded in the form of strands from the extruder into water for cooling, the strands being simultaneously cut with a pelletizer to obtain flame retardant-containing PE resin particles.

The halogen-containing flame retardant may be fed to the extruder together with the PE resin. If desired, halogen-containing flame retardant may be previously mixed with a suitable amount of the PE resin to obtain a master batch having a high flame retardant content. The master batch is then fed to the extruder together with a required amount of the PE resin.

The halogen-containing flame retardant has a melting point (Tm) and/or a glass transition temperature (Tg). The lower of the two temperatures (melting point Tm or glass transition temperature Tg) is represented herein as T2. It is preferred that T2 of the halogen-containing flame retardant is 130 to 350° C., because the halogen-containing flame retardant does not inhibit the formation of cross-linking of the PE resin. Thus, when T2 is within the above range, PE resin expanded beads with good appearance may be obtained. Further, the obtained PE resin expanded beads show good in-mold moldability and can give an in-mold molded article with a desired shape. From this point of view, T2 is more preferably 133 to 300° C., still more preferably 135 to 250° C.

As defined above, T2 is a melting point Tm or a glass transition temperature Tg of the halogen-containing flame retardant, whichever is the lower. When the halogen-containing flame retardant has Tg only and does not have Tm, then the Tg is T2. When the flame retardant has Tm only and does not have Tg, then the Tm is T2. When the flame retardant has both Tg and Tm, the lower of the two is T2. In general, Tg is lower than Tm.

The melting point Tm of the halogen-containing flame retardant is measured in accordance with the heat flux differential scanning calorimeter measurement based on JIS K7121 (1987) after test pieces have been subjected to Conditioning of Test Pieces described in 3(1). The melting point Tm is the peak top temperature of the largest endothermic peak on the measured DSC curve.

The glass transition temperature Tg of the halogen-containing flame retardant is measured in accordance with the heat flux differential scanning calorimeter measurement based on JIS K7121 (1987) after test pieces have been subjected to Conditioning of Test Pieces described in 3(1). The glass transition temperature Tg is the midpoint glass transition temperature determined on the measured DSC curve.

The halogen-containing flame retardant may be, for example, (i) brominated epoxy resins having a structure in which bromine atom or atoms are introduced into the epoxy resin molecules; (ii) halogenated aromatic compounds and their derivatives, such as hexabromobenzene, pentabromotoluene, brominated stylene-butadiene-styrene, brominated polyphenylene ether and brominated polystyrene; (iii) halogen- and nitrogen-containing compounds such as ethylenebis(tetrabromophthal)imide, tris(tribromophenoxy)triazine and tris(2,3-dibromopropyl)isocyanurate; (iv) halogenated aliphatic compounds such as tetrabromocyclooctane; (v) brominated bisphenol compounds such as tetrabromobisphenol A; and (vi) halogen-containing phosphorus compounds such as tris(tribromoneopentyl)phosphate and tris(bromophenyl)phosphate.

The preferred halogen-containing flame retardants are a brominated epoxy resin, a brominated polyphenylene ether and a brominated triazine compound. Particularly preferred are a brominated epoxy resin and a brominated polyphenylene ether, which are polymer type flame retardants.

One preferred example of the brominated epoxy resin is represented by the following formula:

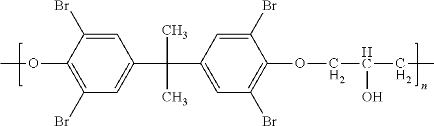

in which n represents an integer showing a degree of polymerization.

A brominated epoxy resin obtained by end-capping part of terminal epoxy groups of an epoxy resin with a bromine compound such as tribromophenol may be also suitably used.

The brominated epoxy resin preferably has a weight average molecular weight of 8,000 to 80,000, more preferably 9,000 to 60,000. The weight average molecular weight herein is determined by gel permeation chromatograph (GPC) using tetrahydrofuran as an eluent and calibrated with polystyrene as standards.

One preferred example of the brominated polyphenylene ether is represented by the following formula:

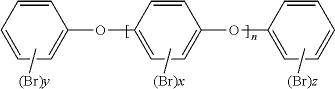

wherein n is an integer showing a degree of polymerization. The brominated polyphenylene ether preferably has a weight average molecular weight of 700 to 3,000.

One preferred example of the brominated triazine compound is a polymer represented by the following formula:

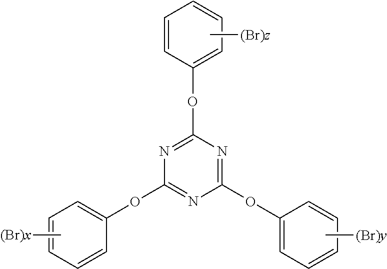

wherein x, y and z each independently represent an integer of 1 to 5.

Among the compounds of the above formula, 1,3,5-triazine compounds in which hydrogen atoms at their 2-, 4- and 6-positions are each independently substituted with a mono-, di-, tri-, tetra- or penta-bromophenoxy group are preferred. More preferred triazine compound is 2,4,6-tris(2,4,6-tribromophenoxy)-1,3,5-triazine.

The halogen-containing flame retardant is preferably present in the PE resin particles in an amount of 3 to 30 parts by weight, more preferably 5 to 25 parts by weight, based on 100 parts by weight of the PE resin for reasons that cross-linked PE resin expanded beads having good flame retardancy, good in-mold moldability and good appearance are obtainable without hindering the cross-linking of the PE resin. Only one kind of the halogen-containing flame retardant may be used. If desired, two or more kinds of halogen-containing flame retardants may be used in combination.

In addition to the halogen-containing flame retardant, the PE resin particles may be incorporated with a flame retardant aid and/or a non-halogen phosphorus flame retardant in a suitable effective amount. As the flame retardant aid, there may be mentioned antimony oxide, zinc stannate and 2,3-dimethyl-2,3-diphenylbutane. The flame retardant aid is preferably antimony oxide, more preferably antimony trioxide and antimony pentoxide, with antimony tritoxide being particularly preferred. The flame retardant aid is preferably used in an amount of 1 to 10 parts based on 100 parts by weight of the PE resin. As the non-halogen flame retardant, there may be mentioned trimethyl phosphate, triethyl phosphate, tributyl phosphate, trioctyl phosphate, tributoxyethyl phosphate, triphenyl phosphate and tricresyl phosphate.

In the dispersing step (a), the PE resin expanded beads containing the halogen-containing flame retardant are dispersed in a dispersing medium contained in a closed vessel such as an autoclave. The dispersing medium is generally an aqueous medium, preferably water, more preferably ion-exchanged water. A liquid or solvent, such as ethylene glycol, glycerin, methanol and ethanol, may be used as the dispersing medium as long as the resin particles are able to be dispersed therein without being dissolved therein. Such a liquid or solvent may be used by itself or in combination with water as the aqueous medium.

If necessary, the dispersing medium may contain a dispersing agent, such as kaolin, mica, alumina and silica, and/or a surfactant, such as an alkylbenzene sulfonate, a lauryl sulfate, a polyoxyethylene alkyl ether phosphoric acid, and a polyoxyethylene alkyl ether sulfate.

### Cross-Linking Step (b):

In the cross-linking step (b), the flame retardant-containing PE resin particles dispersed in the dispersing medium are next impregnated with an organic peroxide cross-linking agent and cross-linked therewith. Any organic peroxide may be used as the cross-linking agent as long as it can cross-link the PE resin. Examples of the organic peroxide cross-linking agent include dialkyl peroxides such as dicumyl peroxide, t-butylcumyl peroxide, 2,5-dimethyl-2,5-di(t-butylperoxy)hexane and di-t-butyl peroxide; peroxyketals such as 1,1-bis(t-butylperoxy)-3,3,5-trimethylcyclohexane; and peroxyesters such as t-hexylperoxy benzoate and 1,1,3,3-tetramethylbutylperoxy-2-ethylhexanoate. Only one organic peroxide may be used as the cross-linking agent or two or more organic peroxides may be used in combination as the cross-linking agent. Preferred organic peroxide cross-linking agent is a PERCUMYL peroxide (dialkyl peroxide) or a PERBUTYL peroxide (peroxyketals), with dicumyl peroxide being particularly preferred. The organic peroxide cross-linking agent is impregnated into the PE resin particles in an amount of 0.1 to 3.0 parts by weight, more preferably 0.2 to 2.5 parts by weight, based on 100 parts by weight of the PE resin particles.

The impregnation of the organic peroxide is preferably carried out at a temperature not lower than the melting point of the organic peroxide since the PE resin particles can be efficiently impregnated with the organic peroxide. From this point of view, the impregnation temperature is more preferably 60 to 130° C., still more preferably 80 to 120° C. It is also preferred that the organic peroxide has a one hour half life temperature (the temperature at which the amount of the organic peroxide decreases to half when the peroxide is heated at that temperature for 1 hour) which is equal to or higher than the impregnation temperature, since decomposition of the organic peroxide during the impregnation stage is prevented and, hence, the PE resin particles can be efficiently impregnated with the organic peroxide. The impregnation temperature is not required to be held constant. As long as the impregnation is carried out at a temperature within the above range, the impregnation temperature may be changed or increased stepwise or continuously at a suitable rate.

The organic peroxide-impregnated, flame retardant-containing PE resin particles are maintained at a cross-linking temperature T1 to cross-link the PE resin with the organic peroxide. It is important that T1 should not be lower than the melting point TM_{PE} of the PE resin and should not be higher than TM_{PE} plus 80° C. (TM_{PE}≦T1≦(TM_{PE}+80° C.)), since otherwise the cross-linking cannot efficiently proceed.

The cross-linking temperature T1 is preferably not lower than the one hour half life temperature of the organic peroxide for reasons of effective formation of cross-linking. The one hour half life temperature of the organic peroxide is preferably 100 to 150° C., more preferably 110 to 145° C. The cross-linking temperature T1 is not required to be held constant. As long as the cross-linking is carried out at a temperature within the above range, the cross-linking temperature T1 may be changed or increased stepwise or continuously at a suitable rate.

It is also important that the cross-linking temperature T1 should satisfy the relationship T1<(T2+30° C.), where T2 is a melting point or a glass transition temperature of the halogen-containing flame retardant, whichever is the lower. When the cross-linking temperature is not lower than T2 plus 30° C., the halogen-containing flame retardant adversely affects the cross-linking reaction of the PE resin with an organic peroxide. Namely, a significant part of the organic peroxide is consumed in the undesirable reaction with the halogen-containing flame retardant. This may result in insufficient cross-linking of the PE resin. In this case, if the organic peroxide is used in an excess amount, decomposition products of the organic peroxide may hinder the foaming and expansion of the PE resin particles. This may result in degradation of the appearance and mechanical properties of the PE resin expanded beads. From this point of view, the cross-linking temperature T1 is preferably not higher than (T2+25° C.). In order for the cross-linking to proceed in the desired degree, the organic peroxide-impregnated, flame retardant-containing PE resin particles are generally maintained at a cross-linking temperature T1 for 1 to 100 minutes, preferably 20 to 60 minutes.

### Blowing Agent Impregnating Step (c):

In this step (c), the dispersed PE resin particles are impregnated with a blowing agent. The step (c) may be preceded by, followed by or concurrent with the step (b). For example, the dispersed PE resin particles may be impregnated first with a blowing agent and then with an organic peroxide, or vice versa. By feeding the blowing agent into the closed vessel containing the PE resin particles dispersed in the dispersing medium and maintained at a temperature higher than the softening point of the PE resin, the dispersed PE resin particles may be impregnated with the blowing agent.

Examples of the blowing agent include a saturated hydrocarbons such as methane, ethane, propane, n-butane, isobutane, cyclobutane, n-pentane, isopentane, neopentane, cyclopentane, n-hexane and cyclohexane; a lower alcohol such as methanol and ethanol; ethers such as dimethyl ether and diethyl ether; and inorganic blowing agents such as carbon dioxide, nitrogen and air. These physical blowing agents may used singly or in combination of two or more thereof. The blowing agent is preferably impregnated in the PE resin particles in an amount of 1 to 10 parts by weight based on 100 parts by weight of the PE resin.

If desired, the flame retardant-containing PE resin particles may additionally contain one or more customarily employed additives such as a nucleating agent, a plasticizer, an antistatic agent, an antioxidant, a UV absorbing agent, a light stabilizer, an electrically conductive filler and an antimicrobial agent. These additives may be added into the PE resin particles in a manner similar to that of the halogen-containing flame retardant.

### Foaming Step (d):

The cross-linked PE resin particles, which have been obtained in the foregoing steps and impregnated with the blowing agent, are foamed and expanded, more specifically are released together with the dispersing medium from the closed vessel to an atmosphere having a pressure lower than that in the closed vessel, generally atmospheric pressure, to foam and expand the cross-linked PE resin particles. The temperature at which the blowing agent-impregnated, cross-linked PE resin particles are released from the closed vessel, namely the foaming temperature, is generally 140 to 180° C. Because the ranges of the foaming temperature and the cross-linking temperature generally overlap each other, the cross-linking of the PE resin may be performed during the course of heating of the PE resin particles to the foaming temperature. When the cross-linking temperature T1 equals foaming temperature, the release of the blowing agent-impregnated, cross-linked PE resin particles from the closed vessel may be carried out as soon as the cross-linking of the PE resin has been completed.

If desired, the flame retardant-containing, cross-linked PE resin particles obtained in the cross-linking step (b) may be isolated from the dispersion contained in the closed vessel without carrying out the blowing agent impregnating step (c) and the foaming step (d).

The isolated cross-linked PE resin particles containing a halogen-containing flame retardant may be used at any time for producing flame retardant-containing cross-linked PE resin expanded beads. Thus, in the same manner as that in the steps (c) and (d), the isolated cross-linked PE resin particles are dispersed in a suitable dispersing medium contained in a closed vessel, into which a blowing agent is then fed to impregnate the PE resin particles therewith. The resulting expandable resin particles are then released from the vessel maintained at elevate temperature and pressure to a lower pressure environment to obtain the desired expanded beads.

If desired, the blowing agent-impregnated, cross-linked PE resin particles obtained in the cross-linking step (b) may be isolated from the dispersion contained in the closed vessel without carrying out the foaming step (d). Because of containing the blowing agent, the isolated, cross-linked PE resin particles are expandable in nature. The expandable cross-linked PE resin particles may be used at any time for producing flame retardant-containing cross-linked PE resin expanded beads. Thus, for example, the expandable PE resin particles are placed in a closed vessel and heated to give the desired expanded beads.

The flame retardant-containing cross-linked PE resin expanded beads obtained by the method of the present invention preferably have an apparent density of 15 to 200 g/L, more preferably 20 to 150 g/L, still more preferably 25 to 100 g/L, for reasons that the expanded beads can give an in-mold molded article having excellent mechanical strength. As used herein, the apparent density of the expanded beads is measured by the following method. Expanded beads (weight: W (g)) are immersed in water contained in a graduated cylinder using a metal wire, etc. From the rise of the water level in the graduated cylinder, the apparent volume V (L) of the expanded beads is determined. The apparent density is calculated by dividing the weight of the expanded beads by the volume thereof (W/V).

The obtained cross-linked PE resin expanded beads preferably have a closed cell content of at least 75%, more preferably at least 80%, still more preferably at least 82%, particularly preferably at least 85%, for reasons that the expanded beads show excellent secondary expansion efficiency and give an in-mold molded article having good mechanical properties.

The obtained cross-linked PE resin expanded beads preferably have a gel fraction of 30 to 70%, more preferably 40 to 65%, for reasons of attainment of the desirable cross-linking structure and excellent moldability.

If desired, the obtained cross-linked PE resin expanded beads may be subjected to a pressurizing treatment with air for increasing the internal pressure thereof and then heated to further expand the expanded beads (two-step expansion) to obtain two-step expanded beads having a higher expansion ratio (lower apparent density).

Any known in-mold molding process may be employed to produce a molded article from the flame retardant-containing, cross-linked PE resin expanded beads obtained by the method of the present invention.

For example, the expanded beads are placed in a mold cavity and heated with steam having a saturated vapor pressure of 0.05 to 0.45 MPa(G), preferably 0.10 to 0.40 MPa(G), so that the expanded beads are fusion-bonded to each other. The obtained molded product is cooled and taken out of the mold cavity, thereby obtaining an expanded bead molded article. The heating with steam may be carried out by a conventional method such as a combination of one-direction flow heating, reversed one-direction flow heating and both-direction flow heating. The particularly preferred heating method includes preheating, one-direction flow heating, reversed one-direction flow heating and both-direction flow heating which are successively performed in this order.

The expanded bead molded article obtained from the above-mentioned cross-linked PE resin expanded beads preferably has an apparent density of 20 to 150 g/L, more preferably 25 to 100 g/L, and a compressive strength of 80 to 200 KPa. Such a molded article has excellent flexibility, vibration damping characteristics, creep resistance characteristics and heat insulating property and, therefore, may be used as packaging and cushioning materials, bed cores, sound damping materials and vibration damping materials for houses, buildings and construction sites.

The method according to the present invention can produce flame retardant-containing, cross-linked PE resin expanded beads which have excellent moldability and which can give an expanded bead molded article having excellent fusion bonding, shape recovering properties and flame retardance.

The expanded bead molded article produced from the above expanded beads preferably has an oxygen index of at least 20 as measured according to a method referenced in JIS K7201-1. When the molded article is used as construction materials, the oxygen index thereof is more preferably at least 26.

The expanded bead molded article produced from the above expanded beads preferably meets with the flammability standards referenced in JIS A9511 (2009) and has self-extinguishing property.

The following examples and comparative examples will further illustrate the invention. The PE resin, flame retardants, flame retardant aid and organic peroxide used in the examples and comparative examples are as follows.

### PE Resin:

A low density polyethylene-based resin (hereinafter referred to “PE1”) manufactured by Japan Polyethylene Corporation and having melting point TEE of 112° C., total heat of fusion of 106 J/g, melt flow rate of 5.2 g/10 min (at 190° C. and load of 2.16 kg) and flexural modulus of 180 MPa was used as a base resin.

### Flame Retardant:

The kind and physical properties of the flame retardants (FD1 to FD6) used in the examples and comparative examples are summarized in Table 1, in which T2 is as defined previously.

### Flame Retardant Aid:

Antimony trioxide (hereinafter referred to as ATO) manufactured by Suzuhiro Chemical Co., Ltd. with a product name of HIROMASTER C-380 was used.

### Organic Peroxide:

Dicumyl peroxide (hereinafter referred to as DPO) having a molecular weight of 270, a melting point of 38° C. and a one hour half life temperature of 136° C. and manufactured by NOF Corporation with a product name of PERCUMYL D was used as a cross-linking agent.

TABLE 1

| | | | | | | | 5% |
|---|---|---|---|---|---|---|---|
| | | | | | | Bromine | Decomposition |
| Flame | | | | | T2 | Content | Temperature |
| retardant | Kind | Compound | Manufacturer | Product Name | (° C.) | (%) | (° C.) |
| FD1 | brominated | brominated | Chemtura Japan | Emerald 1000 | 154 | 78 | 420 |
| | phenoxy | polypnenylene | Limited | | | | |
| | compound | ether | | | | | |
| FD2 | brominated | brominated epoxy | Sakamoto Yakuhin | SR-T5000 | 141 | 52 | 350 |
| | epoxy resin | resin | Kogyo Co., Ltd. | | | | |
| FD3 | brominated | 2,4,6-tris(2,4,6- | Daiichi Yakuhin | SR-245 | 230 | 67 | 350 |
| | triazine | tribromophenoxy)- | Kogyo Co., Ltd. | | | | |
| | compound | 1,3-5-triazine | | | | | |
| FD4 | brominated | 2,2-bis(3,5-dibromo- | Teijin Chemicals Ltd. | FG3100 | 117 | 66 | 270 |
| | bisphenol | 4-2,3-dibromo- | | | | | |
| | compound | phenoxy)propane | | | | | |
| FD5 | brominated | 2,2-bis[4-(2,3- | Daiichi Yakuhin | SR-130 | 110 | 66 | 268 |
| | bisphenol | dibromo-2- | Kogyo Co., Ltd. | | | | |
| | compound | methylpropoxy)- | | | | | |
| | | 3,5- | | | | | |
| | | dibromophenyl]- | | | | | |
| | | propane | | | | | |
| FD6 | brominated | bis[3,5-dibromo- | Suzuhiro Chemical | FCP65CN | 115 | 65 | 299 |
| | sulfone | 4-(2,3- | Co., Ltd. | | | | |
| | compound | dibromopropoxy)- | | | | | |
| | | phenyl]sulfone | | | | | |

### Examples 1 to 8 and Comparative Examples 1 to 7

To an extruder having a diameter of 40 mm, PE resin (PE1) was fed together with a flame retardant (FD1 to FD6), a flame retardant aid (ATO) and zinc borate (manufactured by Tomita Pharmaceutical Co., Ltd.) as a cell controlling agent. The mixture in the extruder was melted and kneaded, and the kneaded mixture was extruded through a die in the form of strands. The strands were cooled, cut into particles and dried to obtain PE resin particles with a weight per particle of 5 mg. The content of the cell controlling agent (zinc borate) in the PE resin particles was 1 part by weight per 100 parts by weight of the PE resin (PE1). The amounts of the flame retardants (FD1 to FD6) and flame retardant aid (ATO) per 100 parts by weight of the PE resin (PE1) were as shown in Tables 2-1 and 3-1.

In a 5 L pressure resisting vessel equipped with a stirrer, 3 L of water as a dispersing medium, 3 g of kaolin as a dispersing agent and 0.04 g of a surfactant (sodium alkylbenzenesulfonate, Trade name: Neogen S-20F, manufactured by Dai-ichi Kogyo Seiyaku Co., Ltd.) were charged, in which 1 kg of the PE resin particles obtained above were dispersed.

To the obtained dispersion, the organic peroxide (DPO) as a cross-linking agent was added in an amount of 1 part by weight per 100 parts by weight of the PE resin (PE1). The contents in the vessel were then heated with stirring to a DPO impregnation temperature (115° C.) shown in Tables 2-1 and 3-1 and maintained at that temperature for 30 minutes to impregnate the PE resin particles with the crosslinking agent (DPO). Subsequently, the resulting dispersion was heated to a cross-linking temperature T2 (160° C.) and maintained at that temperature for 30 minutes to cross-link the PE1 of the PE resin particles with DPO. Thereafter, the resulting dispersion was adjusted at a foaming temperature (160° C.) shown in Tables 2-1 and 3-1. Carbon dioxide (CO₂) as a blowing agent was then injected into the pressure resisting vessel until the pressure within the pressure resisting vessel reached the value (4.0 MPa) shown in Tables 2-1 and 3-1. After having been allowed to stand at that temperature for 30 minutes, the contents were released from the pressure resisting vessel to the atmospheric pressure while applying a back pressure with carbon dioxide to maintain the pressure within the vessel at constant, thereby foaming and expanding the PE resin particles. The thus obtained PE expanded beads had physical properties as shown in Tables 2-1 and 3-1.

It was confirmed that the above crosslinking and impregnation of the blowing agent were able to be concurrently carried out, because the cross-linking temperature was the same as the foaming temperature.

The procedures in Example 1 were repeated in the same manner as described except that the blowing agent impregnation step and the subsequent foaming step were not carried out. Namely, after the cross-linking step had been completed, the dispersion in the vessel were cooled and the cross-linked PE resin particles were isolated. The obtained cross-linked PE resin particles were found to give cross-linked PE resin expanded beads by a conventional expansion method.

The obtained expanded beads were pressurized with air so that the internal pressure of the expanded beads was increased. The expanded beads having an increased internal pressure were then heated with steam to obtain two-step expanded beads having a lowered apparent density. The internal pressure imparted to the expanded beads, the pressure of the steam used in the two step expansion and the apparent density of the two-step expanded beads are shown in Tables 2-2 and 3-2.

The obtained two-step expanded beads were subjected to a pressurizing treatment to impart the internal pressure of 0.1 MPa(G), then filled in a mold cavity of a flat plank mold having a length of 200 mm, a width of 250 mm and a thickness of 50 mm, and then heated with steam having a pressure (molding pressure) shown in Tables 2 and 3 to obtain a molded article in the form of a plank. After completion of the heating, the pressure in the mold cavity was released. The molded article was cooled with water until its surface pressure attributed to its expansion force decreased to 0.02 MPa(G). The mold was then opened. The molded article was taken out of the mold cavity and aged in an oven at 60° C. for 12 hours, thereby obtaining the PE resin expanded bead molded article having physical properties shown in Tables 2-2 and 3-2. The molded articles obtained in Examples 1 to 6 were also measured for their self-extinguishing property, the results of which were as shown in Table 4.

Example 2 employed the flame retardant FD1 in an amount greater than that in Example 1. The expanded beads obtained in Examples 1 and 2 have good in-mold moldability and flame retardancy. Examples 3 and 4 employed the flame retardant FD2 (brominated epoxy resin) and gave molded articles having excellent flame retardancy similar to that in Examples 1 and 2 and also having excellent fusion bonding because of excellent moldability of the expanded beads.

Examples 5 and 6 employed the flame retardant FD3 (brominated triazine) and gave molded articles having excellent flame retardancy similar to that in Examples 1 and 2. The triazine, which had nitrogen atoms in its molecule, shows high affinity with the dispersing agent (surfactant: sodium alkylbenzenesulfonate) and, therefore, the obtained molded article showed fusion bonding percentage of 0%.

Example 7 employed a reduced amount of the flame retardant FD1. Example 8 did not employ any flame retardant aid.

Comparative Examples 1 and 2 did not employ any flame retardant and therefore failed to give desired flame retardancy. In Comparative Examples 3 to 5, the cross-linking temperature T1 was higher than (T2+30° C.). The obtained expanded beads had poor appearance and failed to give an in-mold molded article.

Comparative Example 6 employed the flame retardant FD6 in an amount greater than that in Example 5 but failed to give expanded beads having desired in-mold moldability. Further, the gel fraction of the expanded beads of Comparative Example 6 is 0%, indicating that no cross-linkage was formed. Comparative Example 7 employed the cross-linking agent in an amount much greater than that in Example 5 and, therefore, the gel fraction of 55% was obtained. However, the expanded beads had poor appearance and very poor moldability.

TABLE 2-1

| | | Example | | | | | | | |
|---|---|---|---|---|---|---|---|---|---|
| | | 1 | 2 | 3 | 4 | 5 | 6 | 7 | 8 |
| Base | PE resin | PE1 | PE1 | PE1 | PE1 | PE1 | PE1 | PE1 | PE1 |
| resin | Amount | 100 | 100 | 100 | 100 | 100 | 100 | 100 | 100 |
| | (part by weight) | | | | | | | | |
| Flame | kind | FD1 | FD1 | FD2 | FD2 | FD3 | FD3 | FD1 | FD1 |
| retardant | Amount | 11.5 | 18.8 | 11.5 | 18.8 | 11.5 | 18.8 | 5.4 | 11.1 |
| | (part by weight) | | | | | | | | |
| Flame | Kind | ATO | ATO | ATO | ATO | ATO | ATO | ATO | — |
| retardant aid | Amount | 3.8 | 6.3 | 3.8 | 6.3 | 3.8 | 6.3 | 1.8 | 0 |
| | (part by weight) | | | | | | | | |
| Impregnation | Organic peroxide | DPO | DPO | DPO | DPO | DPO | DPO | DPO | DPO |
| conditions | Amount | 1.0 | 1.0 | 0.8 | 0.8 | 1.0 | 1.0 | 1.2 | 1.0 |
| | (part by weight) | | | | | | | | |
| | Temperature (° C.) | 115 | 115 | 115 | 115 | 115 | 115 | 115 | 115 |
| Cross-linking | Temperature T1 (° C.) | 160 | 160 | 160 | 160 | 160 | 160 | 160 | 160 |
| conditions | Holding time (min) | 30 | 30 | 30 | 30 | 30 | 30 | 30 | 30 |
| Foaming | Temperature (° C.) | 160 | 160 | 160 | 160 | 160 | 160 | 160 | 160 |
| conditions | Autoclave pressure | 4.0 | 4.0 | 4.0 | 4.0 | 4.0 | 4.0 | 4.0 | 4.0 |
| | (MPa) | | | | | | | | |
| Expanded | Apparent density (g/L) | 76 | 77 | 87 | 79 | 77 | 77 | 67 | 75 |
| beads | Appearance | A | A | A | A | A | A | A | A |
| | Closed cell content (%) | 88 | 87 | 93 | 91 | 90 | 86 | 92 | 89 |
| | Gel fraction (%) | 54 | 52 | 61 | 58 | 52 | 47 | 60 | 50 |

TABLE 2-2

| | | Example | | | | | | | |
|---|---|---|---|---|---|---|---|---|---|
| | | 1 | 2 | 3 | 4 | 5 | 6 | 7 | 8 |
| Two step | Internal pressure (MPa) | 0.15 | 0.20 | 0.30 | 0.20 | 0.15 | 0.20 | 0.05 | 0.10 |
| expansion | Steam pressure (MPa) | 0.05 | 0.05 | 0.05 | 0.04 | 0.05 | 0.05 | 0.04 | 0.05 |
| | Apparent density (g/L) | 61 | 62 | 56 | 51 | 43 | 48 | 56 | 61 |
| Molding | Internal pressure (MPa) | 0.10 | 0.10 | 0.10 | 0.10 | 0.10 | 0.10 | 0.10 | 0.10 |
| conditions | Molding pressure (MPa) | 0.12 | 0.12 | 0.12 | 0.10 | 0.10 | 0.10 | 0.12 | 0.12 |
| Molded | Density (g/L) | 38 | 39 | 35 | 32 | 27 | 30 | 35 | 38 |
| article | Fusion bonding rate (%) | 90 | 90 | 100 | 100 | 0 | 0 | 90 | 100 |
| | Closed cell content (%) | 78 | 80 | 83 | 81 | 80 | 75 | 81 | 82 |
| | Compressive strength (KPa) | 130 | 125 | 135 | 122 | 115 | 105 | 125 | 135 |
| | Secondary expansion property | A | A | A | A | A | A | A | A |
| | Shape recovering property | A | A | A | A | A | A | A | A |
| | Oxygen index | 27.0 | 28.0 | 26.0 | 26.5 | 26.5 | 27.5 | 24.5 | 21.0 |

TABLE 3-1

| | | Comparative Example | | | | | | |
|---|---|---|---|---|---|---|---|---|
| | | 1 | 2 | 3 | 4 | 5 | 6 | 7 |
| Base | PE resin | PE1 | PE1 | PE1 | PE1 | PE1 | PE1 | PE1 |
| resin | Amount (part by weight) | 100 | 100 | 100 | 100 | 100 | 100 | 100 |
| Flame | kind | — | — | FD4 | FD5 | FD6 | FD6 | FD6 |
| retardant | Amount (part by weight) | — | — | 11.8 | 11.8 | 11.8 | 85.7 | 11.8 |
| Flame | Kind | — | — | ATO | ATO | ATO | ATO | ATO |
| retardant aid | Amount (part by weight) | — | — | 5.9 | 5.9 | 5.9 | 28.5 | 5.9 |
| Impregnation | Organic peroxide | DCO | DCO | DCO | DCO | DCO | DCO | DCO |
| conditions | Amount (part by weight) | 0.8 | 0.8 | 1.0 | 1.0 | 1.0 | 1.2 | 4.0 |
| | Temperature (° C.) | 115 | 115 | 115 | 115 | 115 | 115 | 115 |
| Cross-linking | Temperature T1 (° C.) | 160 | 160 | 160 | 160 | 160 | 160 | 160 |
| conditions | Holding time (min) | 30 | 30 | 30 | 30 | 30 | 30 | 30 |
| Foaming | Temperature (° C.) | 160 | 160 | 160 | 160 | 160 | 160 | 160 |
| conditions | Autoclave pressure (MPa) | 4.0 | 4.0 | 4.0 | 4.0 | 4.0 | 4.0 | 4.0 |
| Expanded | Apparent density (g/L) | 64 | 60 | 160 | 160 | 160 | 160 | 160 |
| beads | Appearance | A | A | C | C | C | C | C |
| | Closed cell content (%) | 92 | 93 | 0 | 0 | 0 | 0 | 0 |
| | Gel fraction (%) | 52 | 53 | 0 | 0 | 0 | 0 | 55 |

TABLE 3-2

| Comparative Example | | 1 | 2 | 3 | 4 | 5 | 6 | 7 |
|---|---|---|---|---|---|---|---|---|
| Two step | Internal pressure (MPa) | — | 0.10 | — | — | — | — | — |
| expansion | Steam pressure (MPa) | — | 0.05 | — | — | — | — | — |
| | Apparent density (g/L) | — | 37 | — | — | — | — | — |
| Molding | Internal pressure | 0.10 | 0.10 | — | — | — | — | — |
| | (MPa) | | | | | | | |
| conditions | Molding pressure | 0.10 | 0.10 | — | — | — | — | — |
| | (MPa) | | | | | | | |
| Molded | Density (g/L) | 40 | 23 | — | — | — | — | — |
| article | Fusion bonding rate | 100 | 100 | — | — | — | — | — |
| | (%) | | | | | | | |
| | Closed cell content | 84 | 80 | — | — | — | — | — |
| | (%) | | | | | | | |
| | Compressive strength | 155 | 95 | — | — | — | — | — |
| | (KPa) | | | | | | | |
| | Secondary expansion | C | C | — | — | — | — | — |
| | property | | | | | | | |
| | Shape recovering | A | A | — | — | — | — | — |
| | property | | | | | | | |
| | Oxygen index | 18.0 | 18.5 | — | — | — | — | — |

TABLE 4

| | Example | | | | | |
|---|---|---|---|---|---|---|
| | 1 | 2 | 3 | 4 | 5 | 6 |
| Self-Extinguishing Property | yes | yes | yes | yes | yes | yes |
| Average Extinguishing Time (sec) | 1.5 | 0.8 | 3.7 | 2.6 | 0.9 | 0 |

The physical properties of the expanded beads and molded articles were measured as follows.

### Appearance of Expanded Beads:

The expanded beads were observed with naked eyes to evaluate the appearance based on the following criteria:

A: Surface depressions and protrusions are hardly observed and surface conditions are good.

B: Surface depressions and protrusions, although not considerable, are observed.

C: Considerable surface depressions and protrusions are observed.

### Closed Cell Content of Expanded Beads:

As used herein, the closed cell content of the expanded beads is measured as follows. The expanded beads are allowed to stand for aging in a constant temperature and humidity room at 23° C. under atmospheric pressure and a relative humidity of 50% for 10 days. In the same room, about 20 cm³ bulk volume of the expanded beads thus aged are sampled and measured for the precise apparent volume Va by a water immersion method. The sample whose apparent volume Va has been measured is fully dried and measured for its true volume Vx according to Procedure C of ASTM D-2856-70 using Air Comparison Pycnometer Type-930 manufactured by Toshiba Beckman Inc. From the volumes Va and Vx, the closed cell content is calculated by the formula shown below. The average (N=5) of the five time-measurements is the closed cell content of the expanded beads.

Closed cell content (%)=(Vx−W/ρ)×100/(Va−W/ρ)

wherein

Vx represents the true volume (cm³) of the expanded beads measured by the above method, which corresponds to a sum of a volume of the resin constituting the expanded beads and a total volume of all the closed cells of the expanded beads,

Va represents an apparent volume (cm³) of the expanded beads, which is measured by a rise of the water level when the expanded beads are immersed in water contained in a measuring cylinder,

W is a weight (g) of the sample expanded beads used for the measurement; and

ρ is a density (g/cm³) of the resin constituting the expanded beads.

Gel Fraction: The gel fraction of the expanded beads is measured as follows. The expanded beads (precise weight W1; about 0.7 g) are placed in a 150 ml round bottom flask, to which 100 ml of xylene is added. The mixture is heated and refluxed with a mantle heater for 6 hours. The mixture is filtered through a 100 mesh wire net to obtain residues. The residues on the wire net are dried in a vacuum drier at 80° C. for at least 8 hours. The weight (W2) of the dried residues is measured. A gel fraction is given as (W2/W1)×100%.

### Secondary Expansion Efficiency:

The secondary expansion efficiency was determined by observation of the molded article with naked eyes and evaluated based on the following criteria.

A: No gaps are found between expanded beads exposed on the surfaces of the molded article. The shape of each of the corners of the molded article is sharp and coincides with that of the corresponding mold cavity.

C: Significant gaps are seen between expanded beads exposed on the surfaces of the molded article. The shape of each of the corners of the molded article is round as compared with that of the corresponding mold cavity.

### Rate of Fusion Bonding Between Expanded Beads:

Fusion bonding rate is evaluated in terms of a proportion (percentage) of the number of expanded beads that underwent material failure based on the number of expanded beads that were exposed on a ruptured cross section obtained by rupturing a molded article. More specifically, a cut with a depth of about 10 mm was formed on the molded article with a cutter knife. The molded article was then broken along the cut line. The ruptured cross section was observed to count a number (n) of the expanded beads present on the cross section and a number (b) of the expanded beads which underwent material failure. The ratio (b/n), in terms of percentage (%), of (b) based on (n) represents the fusion bonding rate.

### Shape Recovering Property:

The shape recovering property of the molded article was determined by measuring the dimensions in the thickness direction thereof. More particularly, the thickness (t1) of the molded article at its center and the thickness (t2) at one of its four corner portions were measured, and then a thickness ratio (t1/t2), in terms of percentage (%), of (t1) based on (t2) was calculated. The shape recovering property was evaluated based on the following criteria.

A: The thickness ratio is 95% or more.
C: The thickness ratio is less than 95%.

The center and corner portion are as follows. On one of the two opposing 200 mm×250 mm surfaces, two, longitudinal and lateral center lines each bisecting the surface are drawn. The intersection of the two center lines is the center. The corner portion is a point which is spaced a distance 10 mm from each of two longitudinal and lateral side ends.

### Closed Cell Content of Molded Article:

The closed cell content of the molded article was determined in the same manner as that for the measurement of the closed cell content of the expanded beads except that a measurement sample had a size of 25×25×30 mm and was cut out from a center part of the molded article (skin should be all cut off).

### Compressive Stress:

A test piece (without surface skins) having a length of 50 mm, a width of 50 mm and a thickness of 25 mm was cut out from the central part of the molded article and was subjected to a compression test in which the test piece was compressed in the thickness direction at a compression rate of 10 mm/min according to JIS K6767 (1999) to measure the load at 50% stress of the test piece. The measured load was divided by the pressure receiving area of the test piece to obtain 50% compressive stress (kPa) which represents the compression stress of the molded article.

### Oxygen Index:

The oxygen index was measured according to JIS K7201. A test piece of a 10×10×150 mm size was cut out from the molded article and attached to a sample holder with its longitudinal axis oriented vertically. While streaming an oxygen-nitrogen mixed gas, the upper end of the test piece was ignited using an ignition device. The ignition device was removed after ignition. Immediately thereafter, the burning time and burning length of the test piece were started to be measured. By changing the oxygen concentration, the minimum oxygen concentration at which the burning time reached 3 minutes or at which the burning length reached 50 mm was determined. The oxygen index (01) is given by the following equation:

Oxygen Index (OI)=(Minimum Oxygen Concentration)×100/(Minimum Oxygen Concentration+Nitrogen Concentration)

### Self-Extinguishing Property:

The self-extinguishing property was determined according to JIS A9511 (Flammability: Measuring Method A). Five test pieces of a 10×25×200 mm size were cut out from the molded article and were each marked with an ignition limit-indicating line and a burning limit-indicating line. After each test piece had been fixed in a position slanted at 45 degrees, a candle flame was moved at a constant rate from the tip of the test piece to the ignition limit-indicating line over a period of about 5 seconds. The candle flame was swiftly retracted as soon as it had arrived at the ignition limit-indicating line. At this point in time, measurement was started to determine a period of time until the test piece stopped burning. Also, presence of burning residues and position at which the test piece stopped burning (extinguishing position) were determined. The above procedures were conducted using the five test pieces. The average of the five measured values of the time period from the start of the measurement until the test piece stopped burning was calculated as “average extinguishing time”. When the average extinguishing time was not more than 3 seconds and when the extinguishing position of each test piece was inside the burning limit-indicating line, the molded article was regarded as being self-extinguishing. In Table 4, “yes” means that the molded article is self-extinguishing.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all the changes which come within the meaning and range of equivalency of the claims are therefore intended to be embraced therein. The teachings of Japanese Patent Application No. 2014-141302, filed Jul. 9, 2014, inclusive of the specification, claims and drawings, are hereby incorporated by reference herein.

What is claimed is:

1. A method for producing cross-linked polyethylene-based resin expanded beads, comprising the steps of:
(a) dispersing polyethylene-based resin particles containing a halogen-containing flame retardant in a dispersing medium that is contained in a closed vessel, said polyethylene-based resin having a melting point of TM_{PE};
(b) impregnating the dispersed polyethylene-based resin particles with an organic peroxide and cross-linking the polyethylene-based resin of the dispersed polyethylene-based resin particles with the organic peroxide at a cross-linking temperature T1 that is not lower than TM_{PE} and is not higher than TM_{PE} plus 80° C.;
(c) impregnating the dispersed polyethylene-based resin particles with a blowing agent; and
(d) then foaming and expanding the resulting cross-linked polyethylene-based resin particles, which have been impregnated with the blowing agent,
wherein the cross-linking temperature T1 satisfies the following relationship:
T1<T2+30° C.
where T2 is a melting point or a glass transition temperature of the halogen-containing flame retardant, whichever is the lower.

2. A method according to claim 1, wherein the resulting cross-linked polyethylene-based resin particles, which have been impregnated with the blowing agent are released from the closed vessel to an atmosphere having a pressure lower than that in the closed vessel to foam and expand the cross-linked polyethylene-based resin particles.

3. A method according to claim 1, wherein T2 is 130 to 350° C.

4. A method according to claim 1, wherein the halogen-containing flame retardant is present in the polyethylene-based resin particles in an amount of 3 to 30 parts by weight based on 100 parts by weight of the polyethylene-based resin.

5. A method according to claim 1, wherein the halogen-containing flame retardant is selected from the group consisting of brominated epoxy resins, brominated polyphenylene ethers and brominated triazine compounds.

6. A method according to claim 1, wherein the halogen-containing flame retardant is a brominated epoxy resin having a weight average molecular weight of 8,000 to 80,000.

7. A method according to claim 1, wherein the halogen-containing flame retardant is a brominated polyphenylene ether having a weight average molecular weight of 700 to 3,000.

8. A method according to claim 1, wherein the dispersed polyethylene-based resin particles is impregnated with the organic peroxide at a temperature of 60 to 130° C.

9. A method according to claim 1, wherein the organic peroxide has a one hour half life temperature of 100 to 150° C.

10. A method according to claim 1, wherein the polyethylene-based resin particles contain antimony trioxide in an amount of 1 to 10 parts by weight based on 100 parts by weight of the polyethylene-based resin.

11. A method according to claim 1, wherein the cross-linked polyethylene-based resin expanded beads have an apparent density of 15 to 200 g/L.
